(19) United States
(12) Patent Application Publication
(10) Pub. No.: US 2012/0225306 A1
(43) Pub. Date: Sep. 6, 2012

(54) BRAZING PROCESS

(75) Inventor: Paul Zheng, Mount Waverley (AU)

(73) Assignee: CERAMIC FUEL CELLS LIMITED, Noble Park, Victoria (AU)

(21) Appl. No.: 13/383,115

(22) PCT Filed: Jul. 9, 2010
(86) PCT No.: PCT/AU2010/000882

§ 371 Date: May 23, 2012

(30) Foreign Application Priority Data
Jul. 10, 2009 (AU) 2009903255

(51) Int. Cl. B32B 18/00; B23K 1/00

(52) U.S. Cl. 428/450; 228/121

(57) ABSTRACT

A brazing process for joining at least two components having ceramic oxide surfaces is described. The brazing filler used in the process comprises a noble metal and a second metal. During the brazing process, the filler is heated in an oxidising atmosphere such as air. The heating is undertaken until at least the noble metal is molten. The molten filler comprises a surface oxide formed from a stable, non-volatile oxide of the second metal that does not significantly alloy with the molten noble metal. The molten filler is able to wet the ceramic oxide surfaces and is subsequently cooled between them to thereby join them together.

### PRIORITY

This application claims priority from AU 2009903255, which is hereby incorporated herein in its entirety.

### FIELD OF THE INVENTION

The present invention relates to the joining of components comprising ceramic oxide surfaces.

### BACKGROUND

Ceramics have excellent mechanical properties such as robustness and corrosion resistance. However, their use is limited by the current inability to economically manufacture large or complex ceramic components comprising a number of smaller parts. The smaller ceramic parts can be easily formed, but weaknesses often exist at the joins between the smaller parts.

Ceramic-based solid oxide fuel cell stacks comprise ceramic components or metal components having ceramic oxide surfaces that require joins which hermetically seal with other components in the stack including those having metal and other ceramic surfaces. Since the fuel cell functions due to the oxygen ion gradient that develops across the electrolyte membrane, for the fuel cell stack to work efficiently, the hermetic seals between components must be stable and gas-tight.

In order to deliver a high integrity join between ceramic oxide surfaces, a bond must form across the joining surfaces (sometimes referred to as faying surfaces) including across any intermediary. This bond must remain stable under the conditions in which the resultant product is used. Where the resultant product is for use in a solid oxide fuel cell stack, the conditions to which it will be exposed include an average operating temperature of at least 750° C., and continuous exposure to an oxidising atmosphere on the cathode side over a life-time of up to about 30,000 hours or more. Depending upon the type of fuel cell, the resultant product may also be continuously exposed to a reducing environment on the anode side.

Brazing is a liquid phase process usually employed to prepare hermetic joins and seals between metal surfaces. The metals are joined by means of a filler, which can react with the metal surfaces during heating. The filler usually alloys with the metal of the faying surfaces to form bonds at the interface. Typical fillers include non-ferrous metals such as noble metals. Brazing is similar to soldering, except the filler used to join the metal surfaces is usually heated to above 450° C., but below the melting point of the metal surfaces.

Ceramic oxide surfaces are inherently difficult to wet with molten brazing fillers comprising a noble metal. The filler typically beads-up on the ceramic oxide surface. The strength of the resultant bond is reduced because the particles of filler and ceramic cannot inter-lock. In other words, when the filler is molten, it does not wet or spread across the ceramic oxide surface so bonds cannot form between the two materials.

One method of overcoming this problem is metallisation. This involves pre-treating the ceramic oxide surface by applying a metal or metal-like surface to the ceramic oxide before the filler is brought into contact with the surface. One of the most widely used methods of metallisation involves applying a powder mixture of glass, molybdenum and manganese to the ceramic surface and heating it in a damp hydrogen atmosphere at 1500° C. This process can be expensive. A further problem with metallisation is that the subsequent brazing process must be conducted under careful temperature control and in an oxygen-free atmosphere, such as under vacuum or inert gas, for example argon. Working under an oxygen-free atmosphere or under a vacuum can be expensive and labour intensive.

Another method of overcoming the problem is referred to as reactive metal brazing. This involves including an active metal such as zirconium or titanium in the brazing filler so that during the brazing operation, a reaction between the active metal and the ceramic oxide at the surface of the component results in the formation of a thin interlayer of a phase rich in oxide(s) of the active metal. This provides a surface to which the filler can more effectively bond. A problem with active metal brazing is that, once again, the process must be conducted under the expensive conditions of careful temperature control and in an oxygen-free atmosphere.

Accordingly, there exists a need for a new or improved method of joining ceramic oxide surfaces together that alleviates at least some of the difficulties of the prior art processes and which can produce a seal that is able to function in the demanding environments to which the resultant product may be exposed.

### SUMMARY OF THE INVENTION

According to the invention there is provided a brazing process for joining respective ceramic oxide surfaces of two components by means of a filler comprising a noble metal and a second metal, the process comprising the steps of:
heating the filler in an oxidising atmosphere until at least the noble metal is molten, wherein the at least partially molten filler comprises a surface oxide formed from a stable, non-volatile oxide of the second metal;
contacting the ceramic oxide surfaces of the two components with the at least partially molten filler whereby the filler wets the ceramic oxide surfaces; and
cooling the filler between the ceramic oxide surfaces to solidify the filler and thereby join the respective ceramic oxide surfaces of the two components; wherein the oxide of the second metal does not significantly alloy with the molten noble metal.

An article formed by the method may be formed of more than two components and opposed surfaces of each component may be joined by the process of the invention.

Also according to the invention, there is provided a product comprising at least two components joined together by a braze filler, wherein the braze filler joins respective ceramic oxide surfaces of the two components and the braze filler comprises a noble metal and an oxide of a second metal, said oxide of the second metal not being significantly alloyed with the noble metal.

In one embodiment, the product comprises a stack of alternating planar, solid oxide fuel cells and metallic gas separator plates. In this embodiment the solid oxide components are joined to the metallic components by way of ceramic oxide surfaces formed on the surfaces of the metallic components.

In another embodiment the product comprises a stack of solid oxide fuel cells and metallic gas separator plates with a metal cover plate between each gas separator plate and adjacent fuel cell. In this embodiment abutting metallic components are joined by way of ceramic oxide surfaces formed on the surfaces of the metallic components, and solid oxide components are joined to metallic components by way of ceramic oxide surfaces formed on the surfaces of the metallic components.

The oxide of the second metal does not significantly alloy with the molten noble metal, which means that the resultant at least partially molten filler (hereinafter for convenience sometimes referred to as “molten filler”) is not homogenous. Any more than about 1 wt % of the oxide of the second metal alloying into the noble metal is considered “significant”. Advantageously there is no oxide of the second metal alloyed with the noble metal.

However, an insignificant amount of alloying will not affect the outcome of the joining process. In embodiments, there may be up to 0.9 wt %, 0.8 wt %, 0.7 wt %, 0.6 wt %, 0.5 wt %, 0.4 wt %, 0.3 wt % 0.2 wt % or 0.1 wt % of the oxide of the second metal that alloys with the noble metal. Because there is insignificant alloying of the components of the molten filler, the molten filler is considered heterogenous. The noble metal forms the bulk of the filler and the oxide of the second metal forms at least a partial surface oxide layer on the molten noble metal. This presents a molten filler having at least a partial metal oxide surface, which is chemically more attractive to a ceramic oxide surface than is the molten noble metal itself.

The brazing process is undertaken in an oxidising atmosphere such as air. Any atmosphere comprising oxygen is suitable, but air is cheap and convenient. The process is not undertaken in an oxygen-free atmosphere. In fact, the process must be undertaken in an atmosphere that facilitates the formation of a metal oxide, i.e. an oxygen containing atmosphere. An enriched oxygen environment could be used, but may be economically undesirable. The oxidising atmosphere has the advantage that the process can be undertaken without the need for a vacuum or the continual application of an inert gas, thereby providing a considerable manufacturing advantage in the form of simplified process steps and a cost saving.

Heating the filler in an oxidising atmosphere encourages the oxide of the second metal to form. Once formed, the face of the molten filler that is or will be adjacent each said ceramic oxide surface is enriched, relative to the bulk of the molten filler, with said oxide of the second metal.

The process of the present invention works by modifying the surface/interface of the molten filler rather than by modifying the surface of the ceramic oxide to improve the wettability of the ceramic oxide surfaces by the molten filler. No pre-metallisation of the ceramic oxide surfaces is required. Furthermore, known reactive element brazing processes are reliant on the formation of a distinct separate phase between an active metal, such as titanium, and the ceramic oxide surface. The new phase comprises one or more chemical compounds distinct from the material from which the ceramic oxide surface is formed and distinct from the material of the molten filler itself. The new phase can be identified when analysis of the brazed join is undertaken. In the present process, it is believed that the wetting/joining between the filler material and the ceramic oxide surfaces is not as a result of and is not reliant on the formation of a distinct, separate, new phase. While such a distinct new phase may form in some systems, for example where nickel is the second metal it may react with an aluminium oxide ceramic oxide to form NiAl₂O₄, in many systems no distinct new phase will form.

The oxide of the second metal may form a continuous oxide layer over the molten noble metal of the filler, but it is not necessarily continuous. It is sufficient for at least a portion of the surface of the molten noble metal to comprise the oxide of the second metal. A discontinuous oxide layer is adequate provided the molten filler is capable of wetting the underlying ceramic oxide surfaces. Advantageously, 100% of the surface area of the molten noble metal has the layer of oxide of second metal. In some embodiments, however, only 10% or less of the surface area of the molten noble metal may be covered with the oxide of the second metal. Any percentage of surface area of the molten noble metal in the range of 100% to 10% or less could be covered with the oxide of the second metal.

In some embodiments, the steps of heating the filler and contacting the ceramic oxide surfaces with the molten filler occur concurrently. In other words, the filler may be heated while retained between the ceramic oxide surfaces. Once molten, the molten filler is maintained in contact with the ceramic oxide surfaces whereby the molten filler wets the ceramic oxide surfaces.

The ceramic oxide surfaces, or one of them, can be a surface of a component made entirely or partly of that ceramic oxide. Such a ceramic oxide can comprise any non-metallic material able to withstand high temperatures without degradation. For example, the ceramic oxide could be a metal oxide such as alumina, zirconia, chromia or beryllia. A standard electrolyte typically used in solid oxide fuel cells is zirconia stabilised with one or more elements, such as yttria (i.e. yttria stabilised zirconia (YSZ)). YSZ is a preferred electrolyte in a fuel cell because of its chemical stability under a variety of operating conditions. The ceramic oxide surface can comprise YSZ or any other ceramic oxide used in a fuel cell.

Alternatively, the ceramic oxide surfaces, or one of them, may be an oxide surface formed on a metal component. The ceramic oxide on the metal may be created when the metal component is heated in an oxidising atmosphere. This heating step may be the heating step by which the filler is at least partially melted. Preferred metal parts include those that will form alumina or chromia at the surface upon heating at high temperatures. Metals which form nickel oxide at the surface are suitable but less preferred. Thus suitable metals include stainless steels, high temperature super alloys, and other heat resistant alloys. Suitable metal surfaces are also disclosed in U.S. Pat. No. 6,843,406, the entire contents of which are incorporated herein by reference.

Accordingly, the process of the invention can be used to join two faying ceramic oxide surfaces, for example a YSZ surface to a YSZ surface. Alternatively, the method can be used to join a ceramic oxide surface such as a YSZ surface to a metal or other component having a ceramic oxide surface. Alternatively again, the method can be used to join two metal or other components having ceramic oxide surfaces. In a preferred embodiment of use of the process or a product of the invention, a solid oxide fuel cell stack, the two ceramic oxide surfaces might advantageously be selected from one or more of zirconia, Cr₂O₃ and Al₂O₃.

The filler used in the brazing process of the invention comprises a noble metal and a second metal. Unlike most base metals, noble metals are resistant to corrosion or oxidation. They tend to be precious metals, often due to their rarity in the crust of the earth. Usually, the noble metal is one which does not itself form a stable non-volatile metal oxide. Preferably, the noble metal matrix of the filler comprises one or more of silver (Ag), gold (Au), platinum (Pt), and palladium (Pd). Silver is preferred because it is commercially available at a reasonable cost. It is also a possible candidate component of solid oxide fuel cells assemblies. Where more than one noble metal is used, the noble metals are advantageously miscible with one another when molten.

The second metal can be any metal that forms a stable, non-volatile oxide. The oxide of the second metal is “non-volatile”, which means that the oxide is at the surface of the molten noble metal rather than forming in a gaseous or vapour phase separate to the solid phase of the second metal. Preferred second metals include aluminium, tin, nickel, cobalt, chromium, iron, zirconium and titanium (Al, Sn, Ni, Co, Cr, Fe, Zr and Ti), and mixtures thereof. The choice of second metal will depend upon the acceptability of the presence of that second metal in the joined product. Molybdenum, tungsten and vanadium are not usually suitable because their oxides are highly volatile, and some have melting points which are too low.

It will be understood that references to particular metals includes such metals when in a commercial grade of purity. Thus incidental impurities may be present in the materials described.

The second metal forms a stable oxide when heated, so excessive amounts of the second metal are undesirable in the filler, since it may degrade the braze quality by creating porosity within the braze. Accordingly, the second metal preferably comprises no more than about 10 wt % of the total weight of metal in the filler with the rest of the weight of the filler made up by the noble metal. The binder component of the filler is not considered when determining the weight percentage of second metal in the filler. The weight ratio of noble metal to oxidisable second metal in the filler is preferably in the range 10:1 to 10,000:1, more preferably in the range 100:1 to 1000:1. In some embodiments, the second metal comprises in the range of from about 0.1 to about 5 wt % of the total weight of the metal in the filler. In one embodiment, the second metal comprises in the range of from about 0.1 to about 1 wt % of the total weight of metal in the filler.

In order to prepare the filler, a powder of the noble metal and a further powder of the second metal can be mixed, preferably in the presence of a binder, which is discussed in more detail below. For reactive second metals such as titanium, the second metal can be provided in the form of a compound for ease of handling. For example, a hydride of the second metal can be provided in powder form instead of the powdered elemental second metal (e.g., titanium hydride (TiH₂) can be used in place of elemental titanium). References herein to “second metal” should be understood to include second metal compounds unless the context requires otherwise.

In embodiments in which a powder comprising the noble metal and a further powder comprising the second metal are provided, in order to combine the powders a vehicle such as a binder or other carrier may be required. The binder acts as a carrier for the powders and provides a lubricating function to facilitate homogeneous mixing of the two metals. In other words, the binder holds the loose metal powders together and facilitates mixing of them. The powders mixed in the binder may provide a slurry or paste comprising the filler.

The selection and use of suitable binders is well known in the art of screen printing of powders and other particulate materials, including screen printing of particulate components for solid oxide fuel cell stacks. Many such binders are commonly used in slurry processing. One example of a suitable binder is a hydroxypropylcellulose ether in 2-ethoxyethanol and ethanol available as a commercial product with the trade name Cerdec™ 80683. It is understood that the specific material is 2-(2-ethoxyethoxy)- hydroypropyl cellulose in ethanol. Another suitable binder is a commercial product sold under the trade name Cerdec 80858, which is believed to be (2-(2-methoxymethylethoxy) methylethoxy)-hydroxypropyl cellulose in propanol.

Typically, the powder particle size of both the noble metal and the second metal is in the range of from about 0.1 micron (μm) to about 100 μm. In general, the finer the average particle size the better the quality of the resultant brazed join, so a fine particle size is preferred. In advantageous embodiments, the powder comprising the noble metal is coarser than the powder comprising the second metal. In other words, the average particle size of the powder comprising the second metal is less than that of the powder comprising the noble metal. In some advantageous embodiments, the powder of the noble metal has an average particle size which falls in the range of from about 1 μm to about 100 preferably about 40 μm to about 50 μm e.g. an average particle size of 44 μm (which is readily commercially available). Advantageously, the powder of the second metal has an average particle size which falls in the range of from about 0.1 μm to about 20 μm, such as about 1 μm to about 6 μm e.g. about 5 μm. In advantageous embodiments, the average particle size of the powder of noble metal is in the range of from about 5 to about 100 times that of the average particle size of the powder of the second metal, for example about 10 or even about 50 times greater. While finer sized powders are generally preferable, finer powders are more expensive and their higher cost may not be justified for the intended purpose.

When two or more noble metals are provided in powder form, they may be distinct metals, such as powdered silver metal and powdered gold metal, or a powdered alloy of noble metals. A powdered alloy may be commercially undesirable due to the expense associated with preparing an alloy powder.

A powder comprising the second metal could also comprise more than one type of metal. For example, the second metal could comprise a mixture of powdered aluminium metal and powdered tin.

If powders of the second metal and noble metal are used to prepare the filler, the optimal content of the second metal may be dependent upon the particle size of the powder and the chemical reactivity of the chosen second metal. In other words, the finer the powder of the second metal, the less of it will be required because of the increase in available surface area. This will be appreciated by the skilled addressee based on the teaching of this specification.

The filler is heated to above the melting point of the noble metal. The filler is preferably heated to a temperature in the range of about 3° C. or to about 15° C. or more above the melting point of the noble metal. If the filler is not heated to at least 3° C. above the melting point, the filler may not be molten enough to spread. If the filler is heated to more than 15° C. above the melting point, the input of energy is unnecessary and has undesirable associated cost. In some embodiments the filler is heated to in the range of from about 5° C. to about 10° C. above the melting point of the noble metal. For example, the melting point of pure silver in air is about 962° C. Thus, when silver is chosen as the noble metal, the brazing temperature can be advantageously in the range of from about 965° C. to about 978° C., preferably 968° C. to 972° C. For embodiments where the noble metal is an alloy of noble metals, the filler is heated to above the solidus temperature for that alloy, preferably 3° C. or more above the solidus temperature, and preferably above the liquidus temperature. The second metal does not have to melt in the molten filler, although it can melt provided it still provides a stable, non-volatile oxide layer or partial layer.

In some embodiments, the filler can be heated until at least partially molten and then brought into contact with a first ceramic oxide surface. The second ceramic oxide surface can then be brought into contact with the molten filler on the first ceramic oxide surface. Alternatively, the filler can be heated until at least partially molten and contact both ceramic oxide surfaces at the same time. In some embodiments, therefore, the filler is heated in place i.e. between the ceramic oxide surfaces as is described in more detail further below.

The process can be used to join at least two components having ceramic oxide surfaces. In cases where there are more than two components they are joined to form one integral product

In some embodiments, the filler is applied to the first ceramic oxide surface and/or the second ceramic oxide surface (and any other surfaces of components to be joined) in the form of a paste or slurry comprising binder. The surfaces can then be brought into contact with one another and heated in air. During heating, the binder burns off, typically at a temperature in the range of from about 350° C. to about 450° C., leaving behind the noble metal and the oxide of the second metal.

In one particular embodiment, a filler in the form of a preform can be pre-prepared by the following steps:
forming the brazing paste/slurry by techniques such as screen printing or dispensing into a ribbon or strip or gasket-type shape with a first thickness. The thickness can be in the range of from about 300 μm to about 500 μm, at which the paste/slurry may be used in the method of the invention;
heating the formed brazing filler at a temperature sufficient to burn-off the binder;
cooling the heated filler, thus producing a flexible solid filler preform; and
compressing the filler preform by rolling it so as to further reduce its thickness and thereby reduce its porosity. In some embodiments, the rolling can be done to reduce the thickness by about 50%.

The consolidation and heating processes used to produce such a high density ribbon, strip or gasket means that use of the filler at a later time is more convenient. During the compression stage which converts the filler preform to the compressed preform, the porosity of the preform can be reduced from about 50 to 60% voidage to less than about 10% voidage.

The brazing time, i.e. the amount of time that the surfaces are kept at the brazing temperature will generally be in the range of from about 10 to 60 minutes. However, the time will vary depending upon the materials used. The skilled person will be capable of determining the sufficient length of time to provide the desired join integrity. The time should be such as to achieve the desired degree of melting of the filler and wetting of the ceramic oxide surfaces.

When heated in an oxidising atmosphere (such as atmospheric air), the second metal in the filler starts to oxidise. As the filler heats up, a layer of finely dispersed oxide particulates of the second metal forms between the filler material and the ceramic oxide surfaces to be brazed. As the temperature is increased further and the noble metal melts, the ceramic oxide surfaces are wetted by the molten noble metal due to the presence of the finely dispersed oxide particulates at the interface. Intimate contact between the braze filler (now molten) and the ceramic oxide surfaces are achieved.

Following brazing, in order to join the ceramic oxide surfaces, the filler is cooled from the brazing temperature to allow the filler to solidify and thereby join the ceramic oxides. Generally, the filler is allowed to cool to room temperature. The optimal cooling rate is dependent on the materials being joined together. The rate is chosen by experience (and some trial and error) and would form a part of the skill set common to those skilled in the art. A cooling rate of about 2° C. per minute is typical.

In the construction of a fuel cell stack comprising a plurality of planar solid oxide fuel cells, it may be required to join sheet-like components face to face where the alternating sheets are respectively a zirconia ceramic (the electrolyte layer of a fuel cell) and a heat resistant alloy which forms a protective layer of Cr₂O₃ on its surface (for example, a gas separator plate or a cover plate). In order to join the sheet-like components, adjacent sheets could be laid with ribbons of compressed filler preform (as described above) positioned therebetween as desired. A suitable load would be placed on the stack of components and the stack then heated to the brazing temperature for a time sufficient to achieve at least melting of the noble metal and wetting of the oxide surfaces, followed by cooling to room temperature. This would result in the alternating ceramic and alloy sheets being brazed rigidly together as a single component.

### BRIEF DESCRIPTION OF THE FIGURES

Preferred embodiments of the invention will now be described with reference to the following illustrations, which are intended to be exemplary only, and in which:

FIG. 1 is a photograph of a filler comprising silver on a YSZ ceramic surface following heating at 970° C. for about 30 minutes;

FIG. 2 is a photograph of a filler comprising silver on a YSZ ceramic surface following heating at 975° C. for about 30 minutes;

FIG. 3 is a photograph of a filler comprising silver and 0.2 wt % of aluminium on a YSZ ceramic oxide surface following heating at 970° C. for about 30 minutes;

FIG. 4 is a photograph of a filler comprising silver and 0.4 wt % of aluminium on a YSZ ceramic oxide surface following heating at 975° C. for about 30 minutes;

FIG. 5 is a photograph of a filler comprising silver and 0.5 wt % of tin on a YSZ ceramic oxide surface following heating at 975° C. for about 30 minutes;

FIG. 6 is a photograph of a filler comprising silver and 0.4 wt % of titanium hydride on a YSZ ceramic oxide surface following heating at 975° C. for about 30 minutes;

FIG. 7 is a photograph of a filler comprising silver and 0.33 wt % of nickel on a YSZ ceramic oxide surface following heating at 975° C. for about 30 minutes;

FIG. 8 is a photograph of a filler comprising silver on a chromium oxide-forming stainless steel surface following heating at 975° C. for 30 minutes; and

FIG. 9 is a photograph of a filler comprising silver and 0.4 wt % aluminium on a chromium oxide-forming stainless steel surface following heating at 975° C. for 30 minutes.

### DESCRIPTION OF PREFERRED EMBODIMENTS OF THE INVENTION

In order to demonstrate the effectiveness of the filler of the present invention in wetting the ceramic oxide surface, the following experiments were undertaken. It will be understood that these experiments show the feasibility of using the method of the present invention to join a ceramic oxide surface to another surface using a brazing filler, even though actual joins are not created. If joins were created, a second surface would be joined to the ceramic oxide surface when the filler was in the molten state.

The embodiments of the invention described in the following examples should be considered exemplary only and non-limiting.

### Example 1

A powder of silver metal was mixed with Cerdec™80683 binder to form a slurry (in the absence of second metal). The silver particles were sized less than 44 μm. Small droplets of the slurry (about 0.1 ml) were placed on a ceramic oxide surface comprising yttria stabilised zirconia (YSZ).

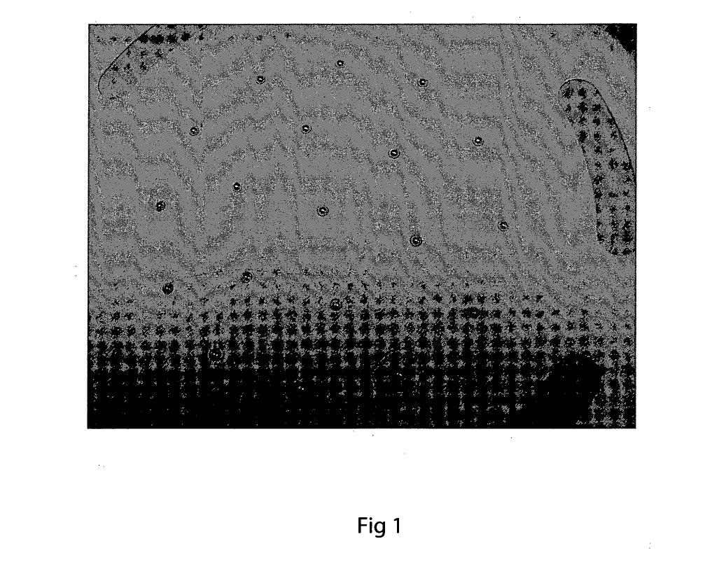

The surface having the filler thereon was heated in air to about 970° C. until molten for a period of about 30 minutes. The surface was then cooled to room temperature. FIG. 1 shows the small beads of silver that result on the ceramic oxide surface. The beading of the silver indicates that the silver did not spread over or wet the ceramic surface under the heating conditions. Visual inspection shows that the silver was poorly bonded to the ceramic oxide surface.

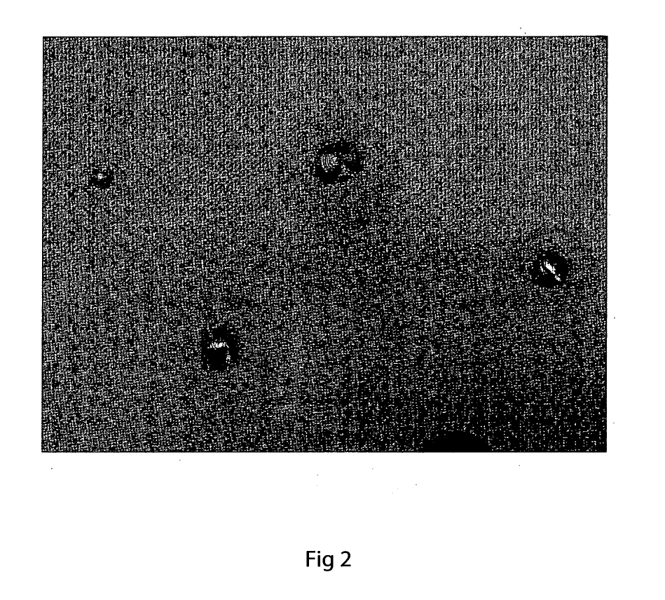

Another YSZ surface having droplets of a filler comprising only silver thereon was heated in air to about 975° C. for a period of about 30 minutes (in the absence of a second metal). The surface was then cooled to room temperature. FIG. 2 shows the silver formed compact beads and did not spread over the ceramic oxide surface.

### Example 2

In order to demonstrate that a second metal added to the filler can improve its ability to wet a ceramic oxide surface, a further powder comprising aluminium was added to the silver powder during preparation of the filler. The powder mixture comprised about 0.2 wt % of aluminium (not including the weight of the binder). The aluminium had an average particle size of 5 μm. The two powders (silver and aluminium) were mixed by stirring together with the binder to form a slurry. Stirring can be done by hand or by means of a mechanical stirrer.

Small droplets of about the same size as those of Example 1 were placed on the same type of ceramic oxide surface used in Example 1. The surface was heated in air to above the melting point of the silver (i.e. to 975° C.) for about 30 minutes and then cooled.

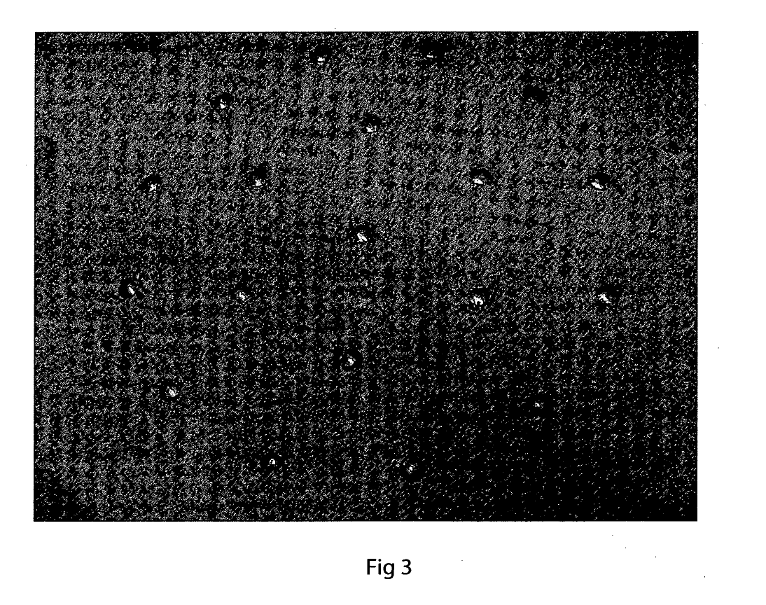

FIG. 3 shows that a filler comprising about 0.2 wt % aluminium has a decreased contact angle with the ceramic oxide surface (compared to the same filler in the absence of the aluminium). The filler has spread and wet the ceramic oxide surface because the interfacial tension between the ceramic oxide and the filler is decreased. The cooled filler was well bonded to the ceramic oxide surface.

### Example 3

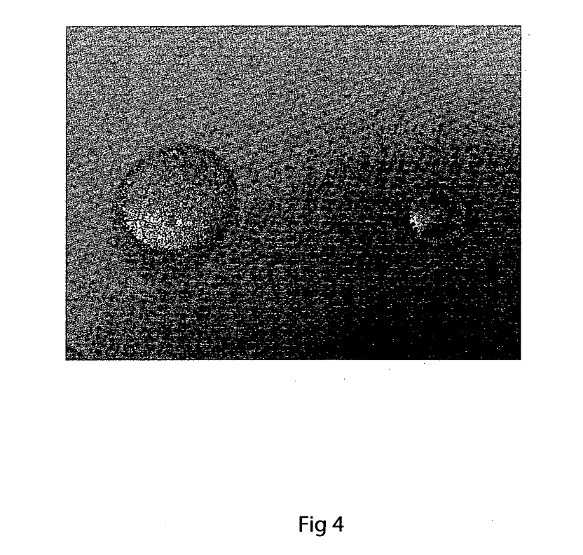

In order to demonstrate that another amount of a second metal added to the filler can improve the wettability of a ceramic oxide surface, 0.4 wt % of the aluminium powder was added to the silver powder during preparation of the filler. Using the same conditions as described in Example 2, except that the heating temperature was 970° C. (which difference is believed to be relatively inconsequential), the filler was melted on the YSZ ceramic surface and then cooled. The increased wettability of the filler on the ceramic oxide, due to the formation of aluminium oxide at the molten filler/vapour interface, is shown in FIG. 4. The cooled filler was well bonded to the ceramic oxide surface.

### Example 4

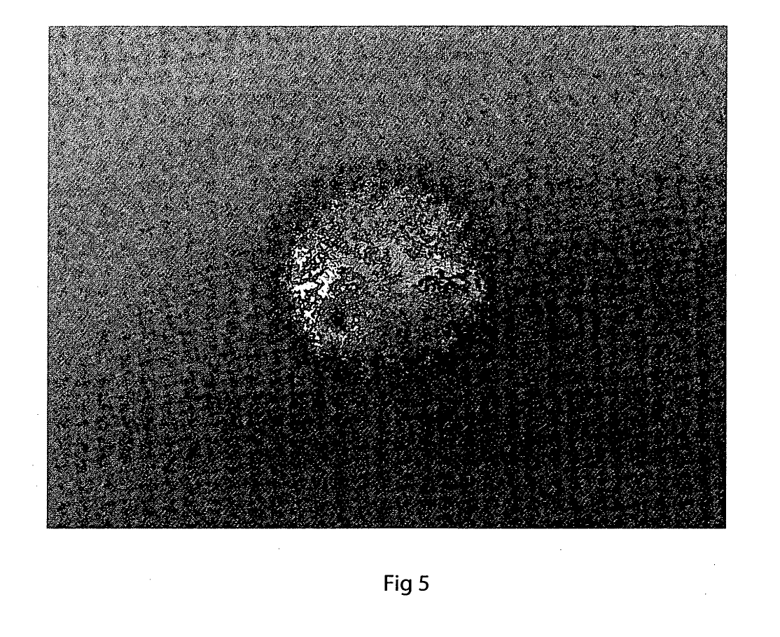

To demonstrate the effectiveness of a different second metal Examples 4, 5 and 6 were undertaken. In Example 4, a powder comprising tin screened at <44 μm was added to the silver powder during preparation of the filler. The powder mixture comprised about 0.5 wt % of tin (not including the weight of the binder). The two powders were mixed with Cerdec™80683 binder to form a slurry. Small droplets of about the same size as those of the preceding Examples were placed on the same type of ceramic oxide surface used in the preceding Examples. The surface was heated in air to 975° C. for about 30 minutes before being allowed to cool to room temperature. FIG. 5 shows that the presence of 0.5 wt % of tin in the filler has caused the silver to wet the ceramic oxide surface. The cooled filler was well bonded to the ceramic oxide surface.

### Example 5

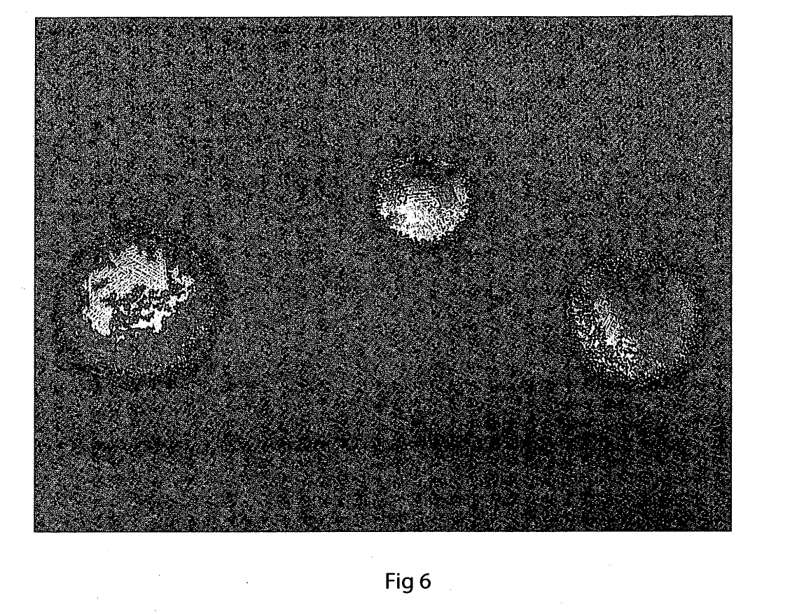

An alternative powder comprising titanium hydride was added to the silver powder during preparation of the filler. The powder mixture comprised about 0.4 wt % of titanium hydride (not including the weight of the binder). The titanium hydride powder was screened to <44 μm. The two powders were mixed with Cerdec™80683 binder to form a slurry. Small droplets of about the same size as those of the preceding Examples were placed on the same type of ceramic oxide surface used in the preceding Examples. The surface was heated in air to 975° C. for about 30 minutes and then cooled to room temperature. FIG. 6 shows that 0.4 wt % of titanium in the filler causes a decrease in the contact angle between the ceramic oxide surface and silver filler. The cooled filler was well bonded to the ceramic oxide surface.

### Example 6

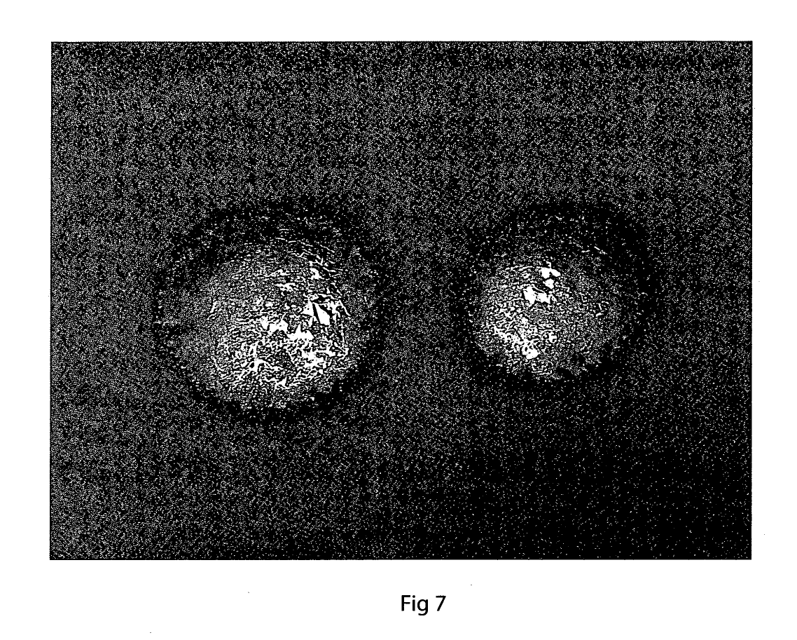

An alternative powder comprising nickel screened at <44 μm was added to the silver powder during preparation of the filler. The powder mixture comprised about 0.33 wt % of nickel (not including the weight of the binder). The two powders were mixed with Cerdec™80683 binder to form a slurry. Small droplets of about the same size as those of the preceding Examples were placed on the same type of ceramic oxide surface used in the preceding Examples. The surface was heated in air to 975° C. for about 30 minutes and then cooled to room temperature. The improved wettability resulting from the addition of nickel is shown in FIG. 7. The cooled filler was well bonded to the ceramic oxide surface.

### Example 7

In order to demonstrate that the second metal also provides an advantage in wetting a metal having a ceramic oxide surface, a silver powder slurry as in Example 1 was heated in air (in the absence of a second metal) on a chromium oxide forming 446 grade stainless steel surface for 975° C. for about 30 minutes until molten and then cooled.

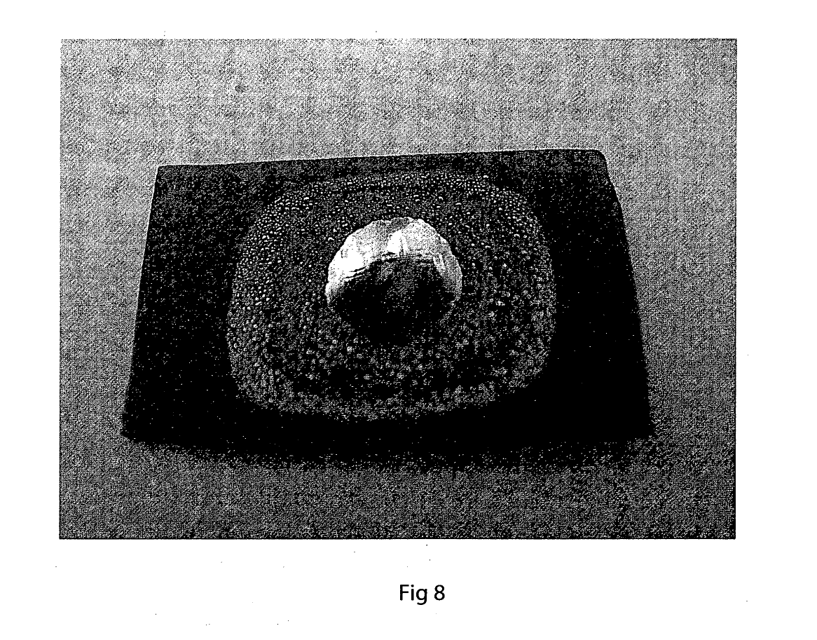

FIG. 8 shows that the silver metal forms beads over the surface. The bulk of the silver does not spread and wet the surface. Visual inspection shows that the silver was poorly bonded to the chromium oxide surface.

### Example 8

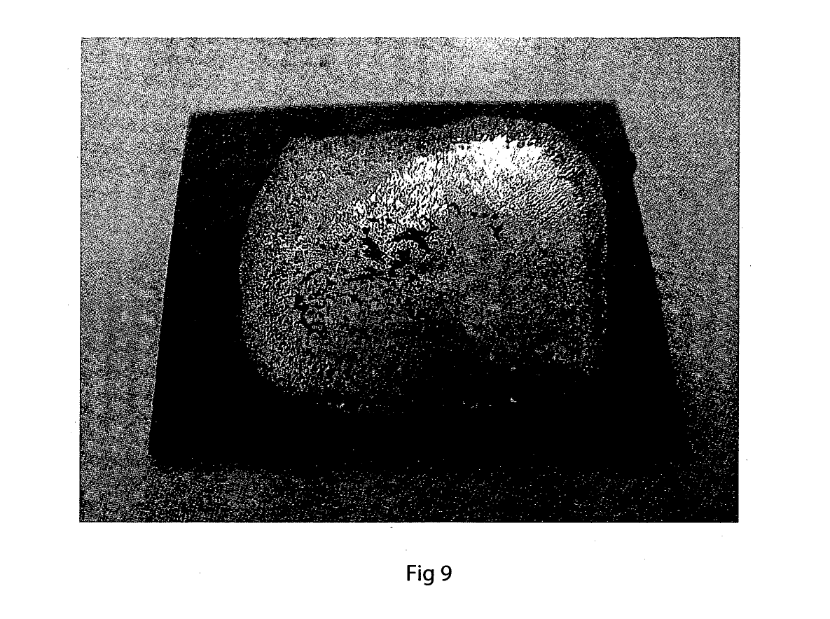

Under the same conditions as Example 7, 0.4 wt % of powdered aluminium having an average particle size of 0.5 μm was added to the silver powder during preparation of the filler. FIG. 9 shows the resultant improvement in surface wettability due to the formation of aluminium oxide at the molten filler/vapour interface. The cooled filler was well bonded to the ceramic oxide surface.

In order to demonstrate the effectiveness of the present invention a brazed join was tested as described in the following example.

### Example 9

Two sheets of heat resistant stainless steel were joined using the filler described in Example 2. The steel was commercial grade ZMG232L sold by Hitachi Metals Ltd. The filler was placed between the sheets and the sheets then heated in a furnace to 975° C. in an air atmosphere for about 30 minutes, with the silver in the filler becoming molten, and then cooled at 2° C. per minute. This steel forms a protective surface coating of chromium oxide at high temperatures which is tightly bonded to the underlying steel and such a coating was formed during the heating step. When cooled, the two sheets were tightly bonded to each other. The two sheets were then subjected to a peel test in order to test the strength of the join. It was found that when failure occurred, it was not within the filler, nor at the interface of the filler and the oxide coating. Instead the failure was at the interface of the oxide coating and the underlying metal, so demonstrating the strength of the bond between the filler and the oxide coating.

Those skilled in the art will appreciate that the invention described herein is susceptible to variations and modifications other than those specifically described. It is to be understood that the invention includes all such variations and modifications which fall within its spirit and scope.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1.-18. (canceled)

19. A brazing process for joining respective ceramic oxide surfaces of two components by means of a filler, the process comprising the steps of:
heating the filler in an oxidising atmosphere;
contacting the ceramic oxide surfaces of the two components with the heated filler whereby the filler wets the ceramic oxide surfaces; and
cooling the filler between the ceramic oxide surfaces to solidify the filler and thereby join the respective ceramic oxide surfaces of the two components;
wherein in the heating and contacting steps, the filler consists essentially of at least one molten noble metal and an oxide component, wherein the oxide component is Rained of one or more stable non-volatile oxides of at least one metal and does not significantly alloy with the molten noble metal and is thereby at the surface of the molten noble metal.

20. The brazing process according to claim 19, wherein the filler is heated while in contact with the ceramic oxide surfaces.

21. The brazing process according to claim 19, wherein the at least one noble metal comprises one or more of silver (Ag), gold (Au), platinum (Pt) and palladium (Pd).

22. The brazing process according to claim 19, wherein the at least one metal comprises one or more of aluminium (Al), tin (Sn), nickel (Ni), cobalt (Co), chromium (Cr), iron (Fe), zirconium (Zr) and titanium (Ti).

23. The brazing process according to claim 19, wherein at least one of the ceramic oxide surfaces comprises one or more of zirconia, such as YSZ, Cr₂O₃ and Al₂O₃.

24. The brazing process according to claim 19, wherein prior to heating the filler comprises a paste or slurry of a powder comprising said at least one noble metal, a further powder comprising the at least one metal, and a binder.

25. The brazing process according to claim 24, wherein at least some of the at least one metal in said further powder is a hydride.

26. The brazing process according to claim 24, wherein the average particle diameter of said powder comprising the at least one noble metal and said further powder comprising the at least one metal is in the range of from 0.1 micron to 100 microns.

27. The brazing process according to claim 24, wherein the average particle size of the further powder comprising the at least one metal is less than the average particle size of the powder comprising the at least one noble metal.

28. The brazing process according to claim 24, wherein the powder comprising said at least one noble metal comprises a powder of a first noble metal and a powder of a further noble metal or a powder of an alloy of noble metals.

29. The brazing process according to claim 24, wherein the further powder comprising the at least one metal comprises a powder of a first metal and a powder of a second metal or a powder of an alloy of metals.

30. The brazing process according to claim 19, wherein the at least one metal comprises up to about 10 wt % of the total metal in the filler.

31. The brazing process according claim 30, wherein the at least one metal comprises in the range of from about 0.1 wt % to about 5 wt % of the total metal.

32. The brazing process according claim 31, wherein the at least one metal comprises in the range of from about 0.1 wt % to about 1 wt % of the total metal.

33. The brazing process according to claim 19, wherein the oxidising atmosphere is air.

34. The brazing process according to claim 19, wherein the filler is heated to in the range of from about 3 to about 15° C. above the melting point of the at least one noble metal.

35. A product comprising at least two components joined together by a braze filler, wherein the braze filler joins respective ceramic oxide surfaces of the components and the braze filler consists of a noble metal and an oxide of one or more of aluminium (Al), tin (Sn), nickel (Ni), cobalt (Co), chromium (Cr), iron (Fe), zirconium (Zr) and titanium (Ti).

36. A brazing process for joining respective ceramic oxide surfaces of two components by means of a filler, the process comprising the steps of:
heating the filler in an oxidising atmosphere;
contacting the ceramic oxide surfaces of the two components with the heated filler whereby the filler wets the ceramic oxide surfaces; and
cooling the filler between the ceramic oxide surfaces to solidify the filler and thereby join the respective ceramic oxide surfaces of the two components;
wherein in the heating and contacting steps, the filler consists essentially of at least one molten noble metal and an oxide component, wherein the oxide component is formed of one or more stable non-volatile oxides of at least one metal and cannot significantly alloy with the molten noble metal and is thereby at the surface of the molten noble metal.
